(19) United States
(12) Patent Application Publication
(10) Pub. No.: US 2019/0342172 A1
(43) Pub. Date: Nov. 7, 2019

(54) SENDING PREDEFINED CONFIGURATION INFORMATION FROM A FIRST COMPUTER TO A SECOND COMPUTER IN A MANAGEMENT NETWORK GROUP

(71) Applicant: Lenovo Enterprise Solutions (Singapore) Pte. Ltd., Singapore (SG)

(72) Inventors: Fred Allison Bower, III, Durham, NC (US); Caihong Zhang, Shanghai (CN)

(21) Appl. No.: 15/968,599

(22) Filed: May 1, 2018

(51) Int. Cl. H04L 12/24

(52) U.S. Cl. CPC H04L 41/0893; H04L 41/0803

(57) ABSTRACT

A computer-implemented method, according to one embodiment includes receiving, by a computer, a designation as a leader to send predefined configuration information to other computers in a management network group. The computer is configured with the predefined configuration information. The computer-implemented method also includes detecting, by the computer, appearance of a second computer in the management network group. The computer-implemented method further includes sending, by the computer, the predefined configuration information to the second computer. A computer-implemented method, according to another embodiment includes joining, by a computer, a management network group of computers where all computers in the management network group are configured according to the same predefined configuration information. The computer-implemented method also includes receiving, by the computer, the predefined configuration information from another computer that is configured with the predefined configuration information. The computer-implemented method further includes applying, by the computer, the predefined configuration information.

### FIELD OF THE INVENTION

The present invention relates to networks, and more particularly, this invention relates to predefined configuration settings in management network groups.

### BACKGROUND

Relatively large scale conventional data center networks are sometimes referred to as hyper-scale data centers. Hyper-scale data center networks may for example include thousands, tens of thousands, or hundreds of thousands of server elements, which when deployed often work on one or more tasks for the overall functionality of the overall network.

In order to fulfill demands, users often assemble and deploy these networks or portions thereof as quickly as possible, such as by configuring and deploying multiple racks at the same time. It may, however, become problematic trying to configure and then maintain a stable configuration of the basic settings in such networks of racks. For example, there may be a fundamental amount of settings that the configuring user wants implemented in a network, e.g., to tune for performance, to secure the network, to facilitate conformity with the network that a device is being installed into, etc.

Such networks however may experience problematic drifting in which the network does not maintain device configuration consistency. For example, in response to technicians manually administrating a machine or making adjustments in the network, the network may lose consistency. Drifting may also occur as a result of a component being replaced in the network, such as where a broken component is replaced and the technician performing the replacing does not know that a “settings refresh” should be performed to sync the replacement component with the previous component's settings.

Another problem in various conventional networks includes an inability to identify new configurations settings, and therefore the new settings are sometimes not incorporated into automated configuration processes.

Conventional networks yet furthermore are often plagued with automation bottleneck thresholds. Specifically, where automation tasks are running on a centralized server, or a centralized set of servers of the network, there is a limit to the scale at which they can operate, e.g., how many units can be simultaneously configured.

### SUMMARY

A computer-implemented method, according to one embodiment includes receiving, by a computer, a designation as a leader to send predefined configuration information to other computers in a management network group. The computer is configured with the predefined configuration information. The computer-implemented method also includes detecting, by the computer, appearance of a second computer in the management network group. The computer-implemented method further includes sending, by the computer, the predefined configuration information to the second computer.

A computer-implemented method, according to another embodiment includes joining, by a computer, a management network group of computers where all computers in the management network group are configured according to the same predefined configuration information. The computer-implemented method also includes receiving, by the computer, the predefined configuration information from another computer that is configured with the predefined configuration information. The computer-implemented method further includes applying, by the computer, the predefined configuration information.

A computer-implemented method, according to yet another embodiment includes receiving, by a computer, a designation as a leader to send predefined configuration information to other computers in a management network group. The computer is configured with the predefined configuration information. The computer-implemented method also includes determining, by the computer, that at least one of the other computers has an inconsistency between the predefined configuration information and the configuration information applied to the at least one of the other computers. The computer-implemented method further includes sending, by the computer, the predefined configuration information to the at least one of the other computers for application of the predefined configuration information by the at least one of the other computers.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is an architecture, in accordance with one embodiment.

FIG. 2 is a representative hardware environment associated with a user device and/or server of FIG. 1, in accordance with one embodiment.

FIG. 3 is a flowchart of a method, in accordance with one embodiment.

FIG. 4 is a management network group environment, in accordance with one embodiment.

FIG. 5 is a management network group environment, in accordance with one embodiment.

FIG. 6 is a management network group environment with a management controller, in accordance with one embodiment.

FIG. 7 is a flowchart of a method, in accordance with one embodiment.

FIG. 8 is a flowchart of a method, in accordance with one embodiment.

FIG. 9 is a flowchart of a method, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of maintaining predefined configuration settings throughout a network group.

In one general embodiment, a computer-implemented method includes receiving, by a computer, a designation as a leader to send predefined configuration information to other computers in a management network group. The computer is configured with the predefined configuration information. The computer-implemented method also includes detecting, by the computer, appearance of a second computer in the management network group. The computer-implemented method further includes sending, by the computer, the predefined configuration information to the second computer.

In another general embodiment, a computer-implemented method includes joining, by a computer, a management network group of computers where all computers in the management network group are configured according to the same predefined configuration information. The computer-implemented method also includes receiving, by the computer, the predefined configuration information from another computer that is configured with the predefined configuration information. The computer-implemented method further includes applying, by the computer, the predefined configuration information.

In yet another general embodiment, a computer-implemented method includes receiving, by a computer, a designation as a leader to send predefined configuration information to other computers in a management network group. The computer is configured with the predefined configuration information. The computer-implemented method also includes determining, by the computer, that at least one of the other computers has an inconsistency between the predefined configuration information and the configuration information applied to the at least one of the other computers. The computer-implemented method further includes sending, by the computer, the predefined configuration information to the at least one of the other computers for application of the predefined configuration information by the at least one of the other computers.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

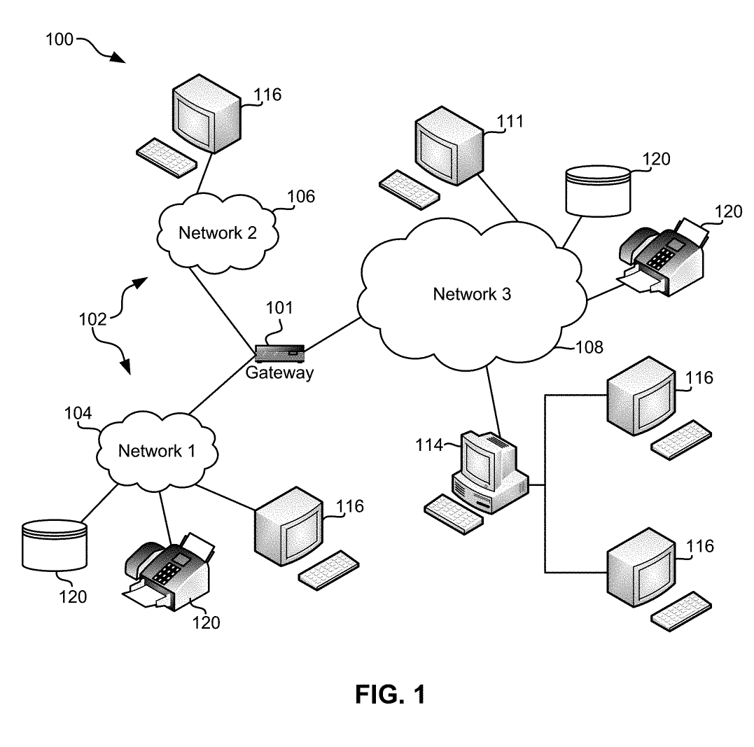

FIG. 1 illustrates an architecture 100, in accordance with one embodiment. As an option, the present architecture 100 may be implemented in conjunction with features from any other embodiment listed herein, such as those described with reference to the other FIGS. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 111 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

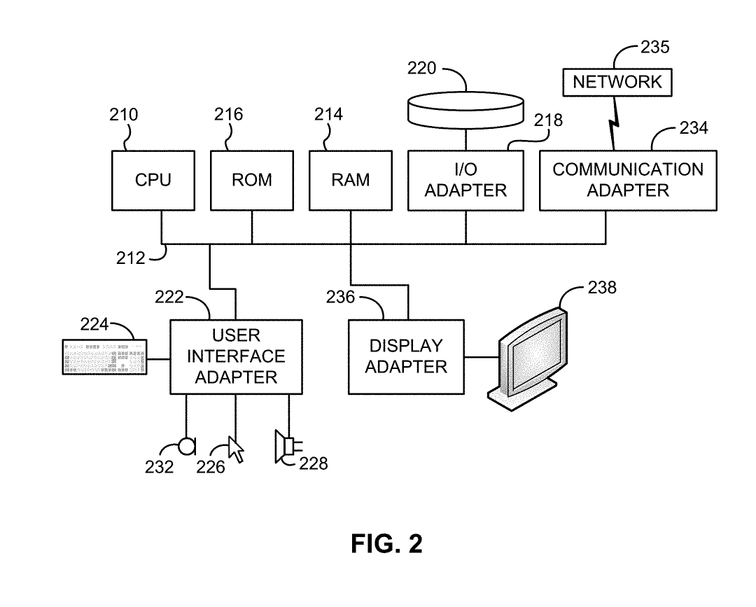

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Hardware environments may include any number of components, and the number of such components may increase or decrease at any time. For example, a server may be added to the hardware environment.

In conventional hardware environments, when a new server is attached to a management network a user is often responsible for connecting the server with the management network. For example, a management network baseboard management controller (BMC), which may be an embedded portion of the new server and serves as a management controller for the server, will include a default configuration, e.g., default credentials, default settings, etc. Typically a user is responsible for altering the out-of-box configuration settings to make the new server compatible with the system in which it is being implemented. For example, a user is often responsible for changing the default credentials configurations, configuring the server's account, and/or any other necessary network adapter and storage adapter configurations, which are often configured one by one. This process is manual, time consuming, and requires administrator interaction and supervision during the initial configuration.

Various embodiments described herein include establishing a peer network with one or more management network groups, in which one or more designated leaders send predefined configuration information to other computers in the management network groups, e.g., for establishing and maintaining at least partially uniform configurations in a data center. Moreover, such embodiments may include automatic discovery and configuration sharing from one peer of the plugged in management network in response to a new server BMC being attached to a management network in the data center.

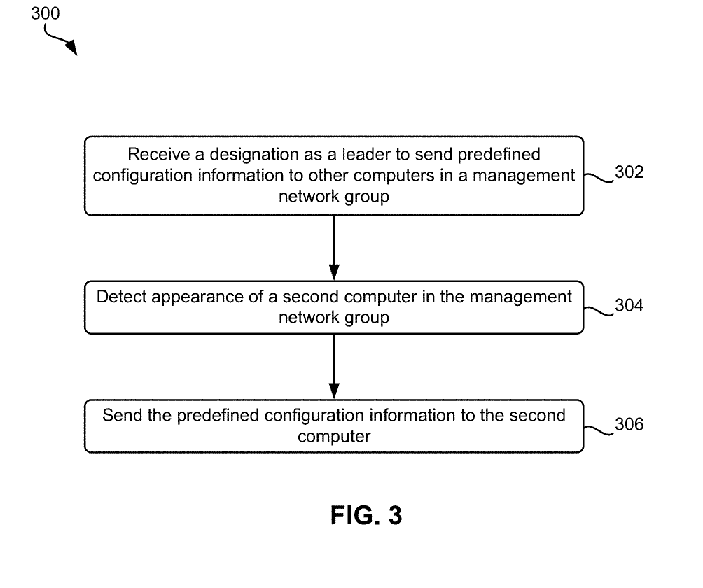

Now referring to FIG. 3, a flowchart of a method 300 is shown according to one embodiment. The method 300 may be performed in accordance with the present invention in any of the environments depicted in FIGS. 1-2, among others, in various embodiments. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

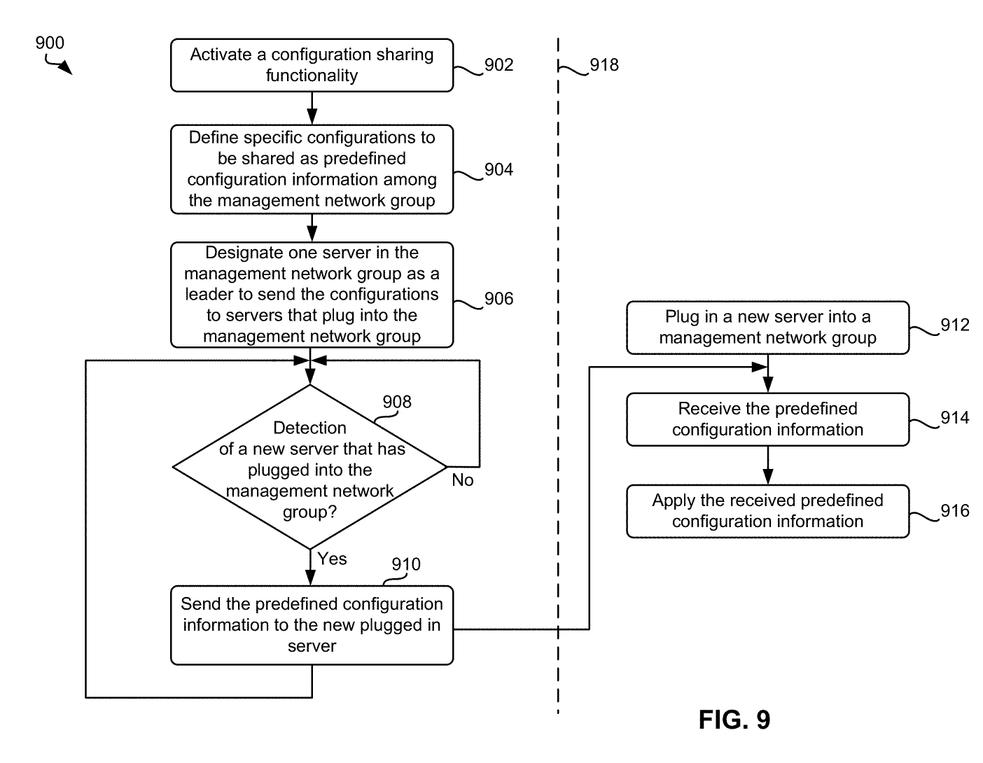

Although method 300 is described to be performed by a computer, it should also be noted that the term “computer” in any of the embodiments described herein may be a computing component in a server, a server or other computer in a management network group, etc. For example, any of the embodiments described herein may be performed by a server, e.g., similar to FIG. 9.

As shown in FIG. 3, method 300 may initiate with operation 302, where a leader designation is received. With respect to the present description, the “leader designation” refers to the process of designating a specific computer as a leader with respect to other computers in a management network group. Thus in preferred approaches, a computer performing the various processes included in method 300 may be designated as a leader with respect to other computers in a management network group as a result of receiving the leader designation in operation 302. In some approaches the leader computer may be designated to send predefined configuration information to other computers in the management network group.

Designating a particular computer as a leader for sending predefined configuration information to other computers in the management network group may be especially important in a management network group where all the computers in the management network group are to use the same predefined configuration information. This is because the designated leader computer may mitigate conflicting information from being applied to different computers in the management network group, which might otherwise occur in response to the computers of the management network group lacking a common understanding of what configuration information should be distributed and/or adhered to.

For reference, according to various approaches, the predefined configuration information may include any type of information for configuring the computers of the management network group. For example, the predefined configuration information may include information that may be used by the computers of the management network group for conforming to the particular requirements of the network and/or management network group. For example, according to some approaches, the predefined configuration information may include, e.g., account configuration information, network adapter configuration information, storage (e.g., RAID) adapter configuration information, etc.

According to other approaches, the predefined configuration information may include server or baseboard management controller settings, e.g., operational modes such as running a performance mode versus a bandwidth preserving mode. In one such approach, the configuration information may be used to configure a mode for the management domain. For example, the configuration information may be used to set up a boot order, which may be used to cause a network boot in a computer versus a local boot or boot from hard disc. According to another example, the configuration information may include information for options that are installed in a computer. For example, an array configuration for a set of locally attached storage or electromagnetic configurations (EMCs) that may span the operational characteristics of a computer. For example, such configurations may include: instructions for how to operate fans, temperature thresholds, sending alerts when temperatures or voltages exceed thresholds, power-on policies, whether a previous state of the computer is to be resumed after experiencing a loss of alternating current (AC) power or alternatively is to remain powered off until a power button is selected, etc.

According to yet further approaches, the predefined configuration information may include basic account configuration information, e.g., how to log into a controller (whether that be for a centralized system like an active directory or a local set of accounts and configuring those local accounts).

The leader computer may itself be configured with the predefined configuration information. For example, according to one approach, the leader computer may already be configured with the predefined configuration information upon the designation being received.

The number of computers of the management network group may vary in accordance with one or more computers being removed from the management network group and/or one or more computers being added to the management network group. Accordingly, operation 304 of method 300 includes detecting appearance of a second computer in the management network group. The detecting of an appearance of a second computer in the management network group may include any known way of detecting computers. According to one approach, the detecting of a second computer may include detecting a signal or notification from the second computer, e.g., a wireless ping, a broadcast notification on the network, etc. According to another approach, the detecting of a second computer may include detecting a physical connection between the second computer and a component of the management network group, e.g., such as a switch, router, etc. that is in communication with the leader computer. According to another approach, the detecting of a second computer may include receiving notification from another component of the management network group.

Operation 306 of method 300 includes sending the predefined configuration information to the second computer.

According to various approaches, the predefined configuration information may be sent, e.g., pushed, to the second computer without a request therefor being received, e.g., from the second computer. For example, in one approach, the predefined configuration information may be sent to the second computer in response to detecting the appearance of the second computer in the management network group. In another approach, the predefined configuration information may be sent to the second computer in response to the leader computer determining that the second computer is not attempting to join the management network group for malicious and/or deceptive reasons, e.g., attempting to mine the management network group with a bot, attempting to upload a virus to one or more computers of the management network group, attempting to change the current configuration information of the management network group, etc.

According to other approaches, the predefined configuration information may be sent to the second computer in response to receiving a request for such information. For example, in one approach, the predefined configuration information may be sent to the second computer in response to receiving a request for configuration information from the second computer. Such a request may be sent separately from any notification, e.g., a ping, that is used by the leader computer to detect the appearance of the second computer in the management network group.

Upon receiving the predefined configuration information sent by the leader computer, the second computer may configure itself with the predefined configuration information.

It should be noted that computers other than the leader computer and the second computer, which may be a part of the management network group, may be at any point be configured with configuration information that is different than the predetermined configuration information received by the leader computer. For example, the other computers may be configured with configuration information that is different than the predetermined configuration information, e.g., upon joining the management network group, in response the computer performing a software update, in response to being instructed to perform a reset, in response to the computer missing an updating of the predetermined configuration information by the leader computer, etc. Accordingly, operations of method 300 may additionally and/or alternatively include auditing the other computers in the management network group for configuration information that does not match the predefined configuration information.

According to one approach, in response to detecting configuration information in one of the other computers that does not match the predefined configuration information, method 300 may include sending the at least a portion of the predefined configuration information to the other computer for replacing the nonmatching configuration information. Similar to sending the predefined configuration information to the second computer, in the current approach, the nonmatching predefined configuration information may be sent to the other computer in an effort to ensure that all computers in the management network are configured with the same configuration information.

It should be noted that using various embodiments described herein, maintaining consistent configuration information throughout a management network group and/or a network of which the management network group is a member is facilitated. This automated consistency desirably improves the functioning of the computer on which such operations are being performed. For example, a person does not have to go in and configure each computer and/or controller of the management network group and/or a network individually. In sharp contrast, banks of servers may be configured simultaneously and automatically by such operations. Misconfigurations may also be avoided as a result of eliminating human interaction, and thereby user error. Moreover, operation of the management network group as a whole is improved because the members thereof have the appropriate configurations to work together as intended.

Of course, at any time during normal operation of the management network group, it may become desirable to update the predetermined configuration information, e.g., where updated configuration information is available, the updated configuration information being different than the predetermined configuration information received in operation 302.

Accordingly, method 300 may include receiving updated configuration information, e.g., received by the leader computer. According to one approach, in response to receiving the updated configuration information, the leader computer may apply the updated configuration information to itself. Moreover, method 300 may additionally and/or alternatively include sending the updated configuration information to the other computers for updating the configuration information on each. Updating the configuration information may cause one or more computers of the management network group to operate more efficiently, e.g., by reducing the number of performed processing operations in the management network group.

According to various approaches, a management network group may include more than one leader computer. For example, according to one approach, the management network group may include a second leader computer, which may be configured to send the same or different predefined configuration information to the other computers of the management network group than the first leader computer.

Accordingly, method 300 may include an additional operation for designating another computer as a second leader to send second predefined configuration information to the other computers in the management network group. In one approach, the second leader computer may be itself configured with the second predefined configuration information.

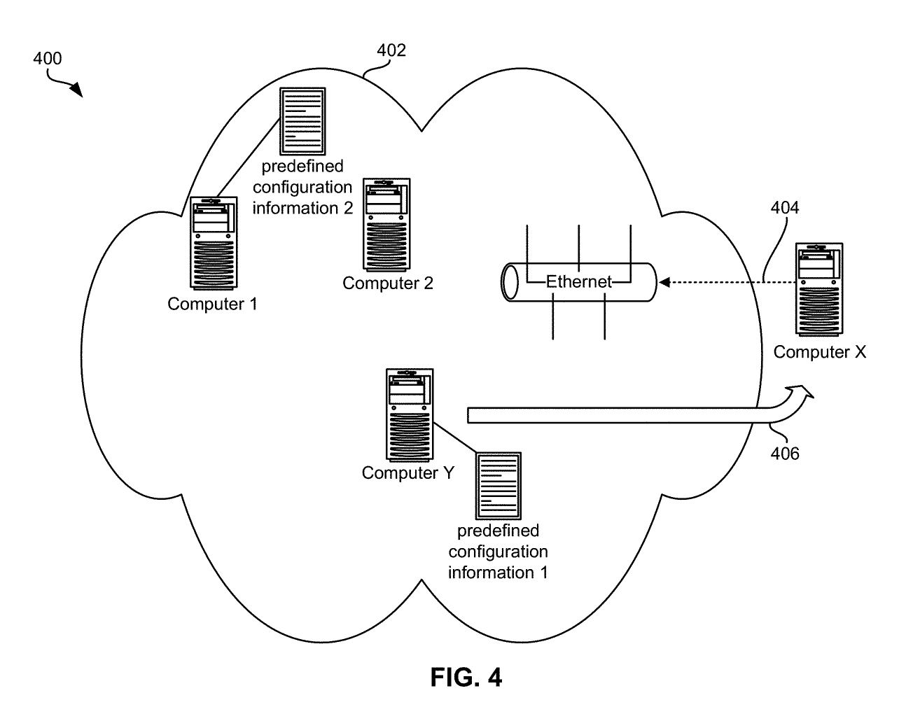

In preferred approaches, the second leader computer is in the same management network group as the first leader computer. However in other approaches, the second leader computer may be in a different management network group as the first leader computer. To provide examples of such approaches, management network group environments 400, 500, 600 of FIGS. 4-6 will now be described in accordance with various embodiments.

FIGS. 4-6 depict management network group environments 400, 500, 600 in accordance with various embodiment. As an option, the present management network group environments 400, 500, 600 may be implemented in conjunction with features from any other embodiment listed herein, such as those described with reference to the other FIGS. Of course, however, such management network group environments 400, 500, 600 and others presented herein may be used in various applications and/or in permutations which may or may not be specifically described in the illustrative embodiments listed herein. Further, the management network group environments 400, 500, 600 presented herein may be used in any desired environment.

Referring now to FIG. 4, the management network group environment 400 includes a management network group 402 with a plurality of computers, e.g., Computer 1, Computer 2, and Computer Y. Similar to various operations of method 300, Computer Y may be designated as a leader computer to send predefined configuration information to other computers in a management network group. For example, see that Computer Y is itself configured with predefined configuration information 1 in environment 400.

According to various approaches, the predefined configuration information 1 may include any type of configuration information, e.g., account configuration information, network adapter configuration information, storage adapter configuration information, etc.

The management network group environment 400 also includes Computer X, which is not initially in the management network group 402. However, Computer X may appear in the management network group 402 upon Computer X being connected to the management network group 402. According to one approach, the detection of Computer X may be made upon receiving a ping 404 from Computer X. According to another approach, as illustrated in FIG. 4, the ping from the Computer X may be directed through an Ethernet router.

Alternatively, Computer X may appear in the management network group 402 in response to Computer X again becoming an active computer, e.g., where Computer X previously went offline from the management network group 402 upon entering a sleep cycle.

The predefined configuration information 1 may be sent to Computer X by leader Computer Y, as represented by arrow 406. As described elsewhere herein, the predefined configuration information 1 may additionally and/or alternatively be sent from the leader Computer Y to any other computers of the management network group 402, e.g., such as Computer 1 and Computer 2. Communication between the computers may be made using any communications mechanism, such as an Ethernet connection, Wi-Fi, direct cable connection, etc.

In one approach, the management network group 402 may also include a second designated leader computer. For example, Computer 1 may be designated as a second leader computer, and may be configured to send second predefined configuration information to the other computers in the management network group. As noted above, the second predefined configuration information may be the same as, or different than, the first predefined configuration information.

For example, assume predefined configuration information 2 is different than predefined configuration information 1. The second leader Computer 1 may send predefined configuration information 2 to any one or more of Computer 2, the leader Computer 1, and the Computer X. In such an example, the second leader Computer 1 may send the predefined configuration information 2 to any one or more other computers, to switch the adhered to predefined configuration information from the predefined configuration information 1 to the predefined configuration information 2. Of course, the preferred predefined configuration information of computers in the management network group 402 may be switched at any time, for any reason.

According to some approaches, the designation of more than one leader computer in the management network group 402 may additionally and/or alternatively be made for purposes of failover when one of the leader computers goes offline and/or becomes non-functional; task assumption when a primary leader computer is too busy to update the other computers, and/or to accomplish task splitting, e.g., updating in parallel. In one approach, each of the leader computers preferably include the same predefined configuration information. For example, assume that Computer Y and Computer 1 are designated as leaders. Also assume that predefined configuration information 1 is the same as predefined configuration information 2 in FIG. 4. In response to determining that the leader Computer Y is non-functional, the leader Computer 1 may become the sole leader of the management network group 402, e.g., at least until Computer Y regains functionality. Accordingly, the leader Computer 1 may perform any of the various operations of method 300 described elsewhere herein, e.g., auditing other computers in the management network group 402, sending the predefined configuration information 1 to one or more computers, detecting appearance of a computer in the management network group, etc.

According to some approaches, the designation of more than one leader computer in the management network group 402 may additionally and/or alternative be made for purposes of distributing tasks in a management network group. For example, a first leader may be responsible for downloading configuration information, while one or more other leaders in the management network group are assigned to send the configuration information to other computers in the management network group. It should be noted that such designations of different responsibilities may vary depending on the degree of task distribution that is desirable, and thus may vary depending on the approach.

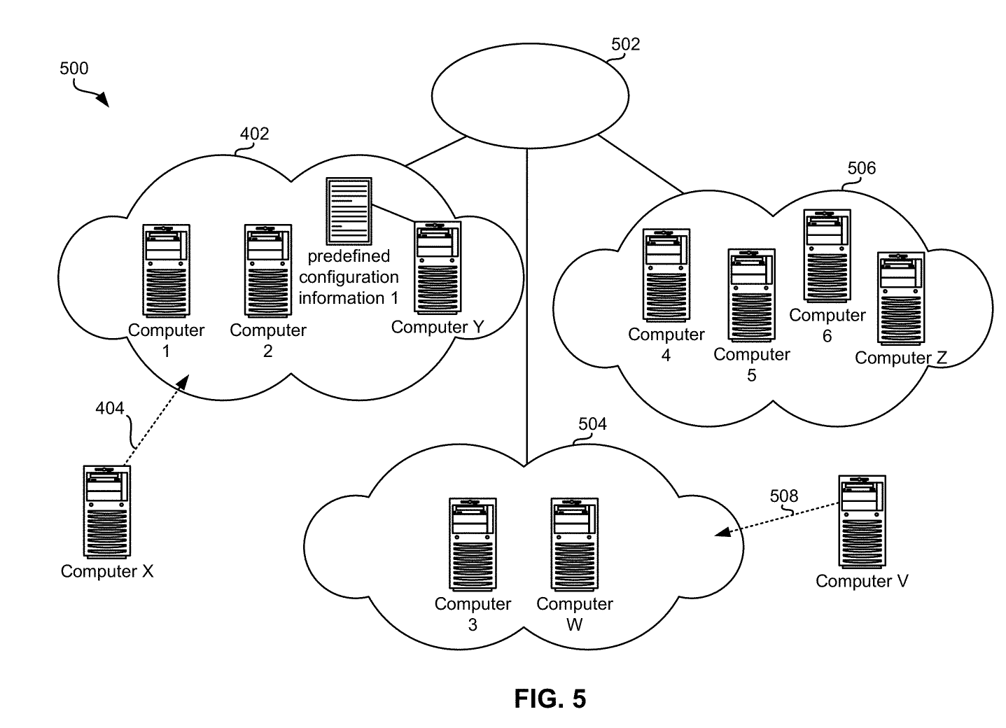

It should be noted that although the second leader is preferably in the same management network group as the first leader, e.g., see FIG. 4, according to some approaches, the second leader may be in a different management network group than the first leader, e.g., see FIG. 5.

Referring now to FIG. 5, the management network group environment 500 includes a network 502 and more than one management network group, e.g., a first management network group 402, a second management network group 504, a third management network group 506, etc.

The first management network group 402 is similar to that shown in FIG. 4. Accordingly, assume that in the present approaches, Computer Y is designated as a leader, and moreover that the leader Computer Y is configured with predefined configuration information 1.

With continued reference to FIG. 5, the second management network group 504 includes a first computer and a second computer, e.g., see Computer 3 and Computer W. Moreover, the second management network group 504 is also shown receiving a ping 508 from Computer V which has just become connected to the second management network group 504. The third management network group 506 includes four computers, e.g., see Computer 4, Computer 5, Computer 6, and Computer Z.

According to various approaches, a leader of a first management network group may detect the appearance of another computer in a management network that is different than the first management network group. Moreover, a determination may be made that the detected computer (of the management network that is different than the first management network group) does not have at least a portion of the predefined configuration information required thereby. Accordingly, at least some of the predefined configuration information may be sent to the detected computer. For example, with continued reference to FIG. 5, the leader Computer Y of the first management network group 402 may detect the appearance of Computer V in the second management network group 504. Such a detection may be made in response to, e.g., detecting the Computer V becoming connected to the second management network group 504, receiving a ping from the Computer V, receiving a request from the Computer V to join the second management network group 504, etc. A determination may be made, e.g., by the leader Computer Y, that Computer V does not have at least a portion of the predefined configuration information 1. Accordingly, at least some of the predefined configuration information may be sent, e.g., by the leader Computer Y, to Computer V, e.g., via network 502.

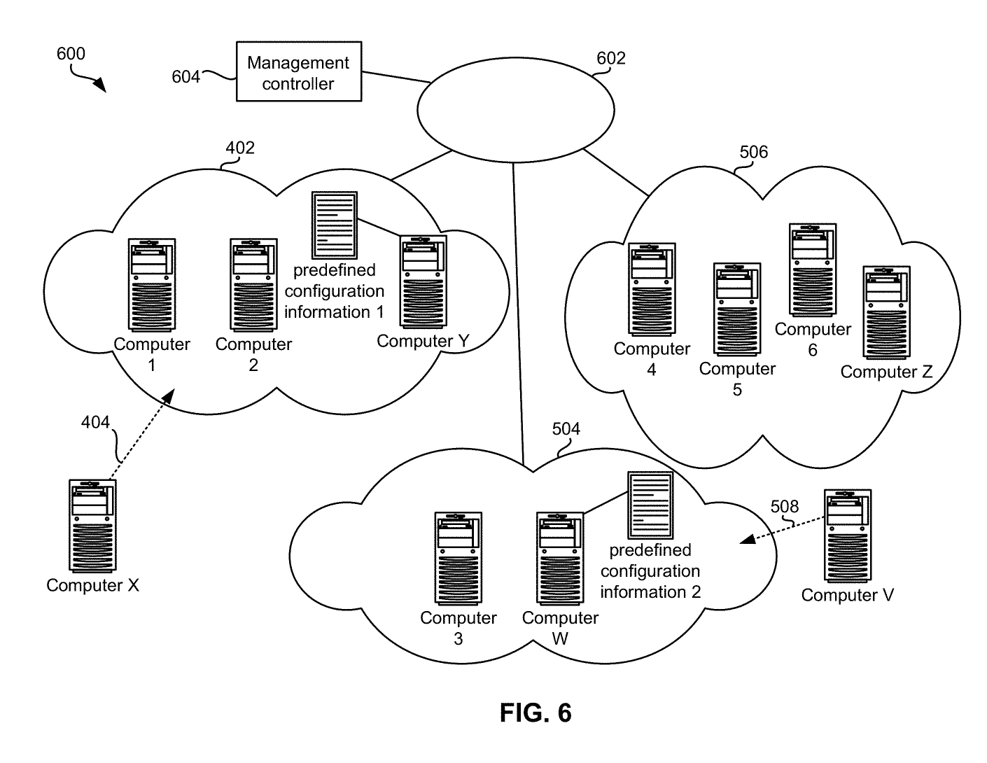

It should be noted that although various approaches of FIG. 5 are configured to have one or more leaders of management network groups performing operations in accordance with the sharing of predefined configuration information, in other approaches, a management network group environment may include a management controller that is configured to direct sharing operations of predefined configuration information among computers, e.g., see FIG. 6.

Referring now to FIG. 6, the management network group environment 600 includes a network 602 and a plurality of management network groups 402, 504, 506. The network 602 of FIG. 6 is similar to the network of FIG. 5, however the management network groups 402, 504, 506 in FIG. 6 are configured to be controlled by a management controller 604. According to various approaches, the controller may be configured to perform and/or direct various operations described herein associated with sharing of predefined configuration information. For example, the management controller 604 may be configured to perform various operations that are described elsewhere herein to be performed by leader computers. According to a more specific example, the management controller 604 may be configured to output a designation of a leader computer. In such an example, the output designation of a leader computer may also include a delegation of a task that the designated leader computer is thereafter to perform.

Implementing a management controller, such as the management controller 604, may be particularly useful in management network group environments which change predefined configuration information one or more times. This is because in some approaches, the management controller may designate different leader computers in different management network groups to be configured with different predefined configuration information. Accordingly, particular leaders may be delegated for particular responsibilities. Such particular responsibilities of a particular leader may be selected for performing a global policy change in the desired configuration information.

Use of a management controller may also be useful in preventing different leaders from interfering with one another. For example, in response to two leaders of the same management network group both detecting a computer that has plugged into the management network group, the management controller may instruct a particular one of the leader computers to send the predefined configuration information to the detected computer. This is important, and prevents the leader computers from both not sending the predefined configuration information to the detected computer, in response to not being able to determine which of the leader computers should do so. However, for embodiments without a management controller to make such determinations for the leader computers, various methods described herein may include operations for determining which leader computer is responsible for sending configuration information in response to multiple leader computers detecting the same computer. For example, in further approaches, leader computers may be assigned different tiers of leadership priority, alternate between which leader computer has a highest ranking, designating a particular leader computer in the environment for sending configuration information when multiple leaders detect a computer in a management network group (an established tiebreaker), etc.

In one approach, the management controller may instruct a first leader to not send a particular predefined configuration information upon a different leader's predefined configuration information being more appropriate for the computers of the management network group environment. For example, the management controller 604 may designate Computer Y and Computer W as leaders. Moreover, the management controller 604 may designate Computer Y to be configured with the predefined configuration information 1, and Computer W to be configured with the predefined configuration information 2. Accordingly, computers of the network 602 may be configured with the predefined configuration information 1 in response to the management controller 604 instructing the leader Computer Y to send at least portions of the predefined configuration information 1 to other computers in the management network group environment 600, and instructing the leader Computer W to not send the predefined configuration information 2 to other computers in the management network group environment 600. Similarly, computers in the management network group environment 600 may be configured with the predefined configuration information 2 in response to the management controller 604 instructing the leader Computer W to send at least portions of the predefined configuration information 2 to other computers, and instructing the leader Computer Y to not send the predefined configuration information 1 to other computers.

Designating more than one of the computers in the management network groups 402, 504, 506 to be leaders desirably results in a reduced load on centralized management of environment 600. For example, as a result of configuring a mass deployment configuration of a plurality of leaders across the management network groups 402, 504, 506, new computers that are plugged into such management network groups 402, 504, 506 may be simultaneously or concurrently configured.

Other advantages offered when using methods described herein in environments such as environment 600 is additional robustness. This additional robustness results from not being dependent on any one leader or any one management computer being functional at any given time in order to have a desired configuration conveyed to new computer. Presuming that various leaders are present in such environments, n-way redundancy is established, provided that such leaders are in the same communication domain such the leaders can see each other when a computer is plugged into a management network group of the environment. Specifically, the robustness is established in the sharing of the burden or ensuring that the predetermined configuration information is delivered in a timely fashion to computers in management network groups.

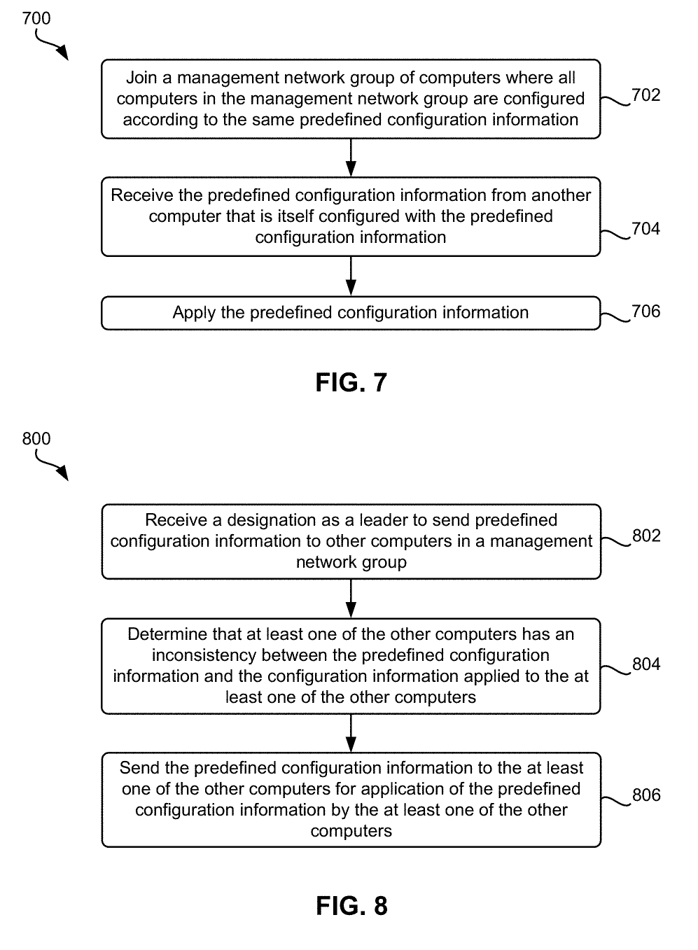

Referring now to FIG. 7, a flowchart of a method 700 will now be introduced and described for purposes of detailing a computer joining a management network group of computers.

Now referring to FIG. 7, a flowchart of a method 700 is shown according to one embodiment. The method 700 may be performed in accordance with the present invention in any of the environments depicted in FIGS. 1-2, and 4-6 among others, in various embodiments. Of course, more or less operations than those specifically described in FIG. 7 may be included in method 700, as would be understood by one of skill in the art upon reading the present descriptions.

Each of the steps of the method 700 may be performed by any suitable component of the operating environment. For example, in various embodiments, the method 700 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 700. Illustrative processors include, but are not limited to, a central processing unit (CPU), an application specific integrated circuit (ASIC), a field programmable gate array (FPGA), etc., combinations thereof, or any other suitable computing device known in the art.

It should be noted that operations of method 700 may preferably be performed by a computer, although according to some approaches, such operations may be additionally and/or alternatively performed in accordance with the instruction of a management controller, e.g., similar to management controller 604 of the management network group environment 600.

With continued reference to FIG. 7, method 700 may initiate with operation 702, which includes joining, e.g., by a computer, a management network group of computers where all computers in the management network group are configured according to the same predefined configuration information. For example, all computers in the management network group may have the same type of configuration for some aspect of the deployment, such as the same storage adapter configuration, the same network adapter configuration, and/or the same account configuration, etc.

A computer joining a network may be initiated by the computer establishing electrical and/or wireless connectivity with the management network group of computers. For example, according to one approach, a computer joining a management network group of computers may include a component of the computer being plugged into a port associated with the management network group of computers. According to another example, a computer joining a management network group of computers may include the computer joining and/or attempting to join a protected wireless connection associated with the management network group of computers.

In response to joining the management network group of computers, method 700 may include the computer sending a request for predefined configuration information of the management network group of computers. The computer may request such predefined configuration information for configuring itself to operate efficiently with the other computers of the management network group of computers, e.g., in response to the computer configuring itself with the predefined configuration information of the management network group.

Accordingly, operation 704 of method 700 includes receiving the predefined configuration information from another computer that is itself configured with the predefined configuration information.

According to some approaches, the predefined configuration information received in operation 704 may not depend on a request being sent for such information. For example, according to one approach, the predefined configuration information may be received from the other computer without a request therefor being sent by the computer. According to a more specific example, the predefined configuration information may be received automatically in response to successfully joining the management network group of computers.

According to some other approaches, the predefined configuration information received in operation 704 may additionally and/or alternatively be received in response to detecting that a computer has had a change of a component, resulting in the computer not being configured with the predefined configuration information. For example, as a result of a networking card of the computer being changed, the computer may need to be reconfigured to operate in conformance with the requirements of the network and/or the management network group in which method 700 is being performed. Accordingly, method 700 may include sending a request for the predefined configuration information upon detecting a hardware change in the computer. The request may be sent by the computer upon detecting the change of component.

Operation 706 of method 700 includes applying the predefined configuration information received in operation 704. This applying of the predefined configuration information may enable the computer to be in conformance with the configuration information that is called for at that time in the management network group. Accordingly, the computer becomes configured with the same predefined configuration information as the other computers in the management network group.

Now referring to FIG. 8, a flowchart of a method 800 for a designated leader maintaining consistency and populating configuration changes to other computers in a management network group is shown according to one embodiment. The method 800 may be performed in accordance with the present invention in any of the environments depicted in FIGS. 1-2, and 4-6 among others, in various embodiments. Of course, more or less operations than those specifically described in FIG. 8 may be included in method 800, as would be understood by one of skill in the art upon reading the present descriptions.

Each of the steps of the method 800 may be performed by any suitable component of the operating environment. For example, in various embodiments, the method 800 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 800. Illustrative processors include, but are not limited to, a central processing unit (CPU), an application specific integrated circuit (ASIC), a field programmable gate array (FPGA), etc., combinations thereof, or any other suitable computing device known in the art.

It should be noted that operations of method 800 may preferably be performed by a computer, although according to some approaches, such operations may be performed in accordance with the instruction of a management controller, e.g., similar to management controller 604 of the management network group environment 600.

As shown in FIG. 8, method 800 may initiate with operation 802, which includes receiving a designation as a leader, e.g., as a leader computer, to send predefined configuration information to other computers in a management network group where all computers in the management network group are to use the same predefined configuration information. The leader computer is itself preferably configured with the predefined configuration information.

Operation 804 of method 800 includes determining that at least one of the other computers has an inconsistency between the predefined configuration information and the configuration information applied to the at least one of the other computers. Inconsistencies between the predefined configuration information of computers in a management network group may result in processing inefficiencies and/or failures. Accordingly, it may be desirable to determine if such inconsistencies exist, and if so mediate them.

According to one approach, the determining that the at least one of the other computers has an inconsistency may include auditing the other computers in the management network group for configuration information that does not match the predefined configuration information. For example, an auditing of the other computers in the management network group for configuration information that does not match the predefined configuration information may include comparing related portions of the predefined configuration information of the leader computer and another computer. According to another example, an auditing of the other computers in the management network group for configuration information that does not match the predefined configuration information may include searching for outdated configuration information in the other computers.

According to another approach, an inconsistency may be determined to be present between the predefined configuration information and the configuration information applied to the at least one of the other computers in response to receiving updated configuration information.

Operation 806 of method 800 includes sending the predefined configuration information to the at least one of the other computers for application of the predefined configuration information by the at least one of the other computers. According to some approaches, the predefined configuration information sent to the at least one of the other computers may include all of the predefined configuration information. However, in other approaches, it may be preferable to send only a portion of the predefined configuration information. For example, in response to detecting, e.g., as result of an auditing of one or more other computers, configuration information that does not match the predefined configuration information in one of the other computers, the nonmatching predefined configuration information may be sent to the other computer for replacing the nonmatching configuration information.

It should be noted that although method 800 includes the leader computer sending the predefined configuration information to other computers, in some approaches method 800 may additionally and/or alternatively include the leader computer updating itself. For example, in one approach, where the inconsistency is determined in response to the computer receiving updated configuration information, method 800 may include applying the updated configuration information to the leader computer itself. Additionally, in order for all of the computers to conform in configuration to the updated configuration information of the computer, the computer may send the updated configuration information to the other computers for updating the configuration information on each.

Now referring to FIG. 9, a flowchart of a method 900 for maintaining consistency and populating configuration changes to servers in a management network group is shown according to one embodiment. The method 900 may be performed in accordance with the present invention in any of the environments depicted in FIGS. 1-2, and 4-6 among others, in various embodiments. Of course, more or less operations than those specifically described in FIG. 9 may be included in method 900, as would be understood by one of skill in the art upon reading the present descriptions.

Each of the steps of the method 900 may be performed by any suitable component of the operating environment. For example, in various embodiments, the method 900 may be partially or entirely performed by a server, or some other device having one or more processors therein. The processor, e.g., processing circuit(s), chip(s), and/or module(s) implemented in hardware and/or software, and preferably having at least one hardware component may be utilized in any device to perform one or more steps of the method 900. Illustrative processors include, but are not limited to, a central processing unit (CPU), an application specific integrated circuit (ASIC), a field programmable gate array (FPGA), etc., combinations thereof, or any other suitable computing device known in the art.

It should be noted that line 918 in FIG. 9 distinguishes between operations that may be performed by servers that are members of a management network group (operations 902-910), and operations that may be performed by a server that is joining a management network group (operations 912-916). Operations 902-910 may more specifically correspond to operations that may be performed by a designated leader server.

Method 900 may be initiated by operation 902, which includes activating a configuration sharing functionality. The configuration sharing functionality may correspond to functions of one or more servers of a management network group. Accordingly, the activation of a configuration sharing functionality may be performed by any one or more servers of the management network group.

Operation 904 of method 900 includes defining specific configurations to be shared as predefined configuration information among the management network group. According to various approaches, the predefined configuration information may include any type of configuration. For example, according to various approaches, the predefined configuration information may include account configuration information, network adapter configuration information, storage adapter configuration information, etc.

Similar to a leader computer designation of other embodiments described elsewhere herein, operation 906 of method 900 includes designating one server in the management network group as a leader to send the configurations to servers that plug into the management network group. The leader server may be used to maintain uniform functionality configurations throughout one or more management network groups, in response to the leader sending the predefined configuration information to other servers.

Because new servers that are plugged into the management network group may include configuration information that is different than the predefined configuration information, method 900 may include detecting such new servers. Accordingly, decision 908 of method 900 includes determining whether a detection of a new server that has connected to (e.g., plugged in to) the management network group has been made.

If no new server is detected in decision 908, the system continues to wait for detection of a new server (see the “No” logical path from decision 908).

In response to detecting a new server becoming connected to the management network group (see the “Yes” logical path from decision 908), the predefined configuration information may be sent to the new server, e.g., see operation 910. Monitoring for new servers may continue.

Referring now to operations 912-916, operation 912 includes a new server connecting to a management network group. Assuming that the server of operation 912 is detected at decision 908, the server may receive the predefined configuration information, e.g., see operation 914.

Operation 916 includes the server applying the received predetermined configuration information.

As a result of the server applying the received predetermined configuration information, each of the servers of the management network group may be configured with the predetermined configuration information.

Of course as described in other embodiments elsewhere herein, the leader server may continue to detect, e.g., servers plugging into the management network group, servers including nonconforming configuration information, designation of new predetermined configuration information, etc., for maintaining uniform configuration settings in the network. This will result in an efficiently operating network that requires little if any configuration tuning by a user.

It should be noted that various embodiments and/or approaches described herein may be complementary to existing network configuration management. For example, such embodiments and/or approaches may be used complementarily with a script or a managing server that already pushes configurations to elements of an environment. For example, where a management server sends and/or configures to a desirable configuration before a leader is designated, the leader will not have to send out predefined configuration information, as the configuration has already been established correctly. This may be useful in an environment where the use of multiple leaders is not desirable, because doing so would potentially be a security exposure, e.g., one of the leaders could be attacked and cause nefarious configuration changes to happen across a population. In such an example, the leaders would instead be relied on as simply a back-up method.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A computer-implemented method, comprising:
receiving, by a computer, a designation as a leader to send predefined configuration information to other computers in a management network group, the computer being configured with the predefined configuration information;
detecting, by the computer, appearance of a second computer in the management network group; and
sending, by the computer, the predefined configuration information to the second computer.

2. The computer-implemented method as recited in claim 1, wherein the predefined configuration information is sent to the second computer without a request therefor being received by the computer.

3. The computer-implemented method as recited in claim 1, wherein the predefined configuration information includes configuration information selected from the group consisting of: account configuration information, network adapter configuration information, and storage adapter configuration information.

4. The computer-implemented method as recited in claim 1, comprising auditing the other computers in the management network group for configuration information that does not match the predefined configuration information; and in response to detecting configuration information that does not match the predefined configuration information in one of the other computers, sending the predefined configuration information to the other computer.

5. The computer-implemented method as recited in claim 1, comprising receiving, by the computer, updated configuration information; applying the updated configuration information to the computer; and sending, by the computer, the updated configuration information to the other computers.

6. The computer-implemented method as recited in claim 1, comprising detecting, by the computer, appearance of a third computer in a second management network group; determining that the third computer does not have at least a portion of the predefined configuration information required thereby; and sending, by the computer, at least some of the predefined configuration information to the third computer.

7. The computer-implemented method as recited in claim 1, wherein another computer is designated as a second leader to send second predefined configuration information to the other computers in the management network group, the second leader being configured with the second predefined configuration information.

8. A computer-implemented method, comprising:
joining, by a computer, a management network group of computers where all computers in the management network group are configured according to the same predefined configuration information;
receiving, by the computer, the predefined configuration information from another computer that is configured with the predefined configuration information; and
applying, by the computer, the predefined configuration information.

9. The computer-implemented method as recited in claim 8, comprising sending, by the computer, a request for the predefined configuration information.

10. The computer-implemented method as recited in claim 8, wherein the predefined configuration information is received from the other computer without a request therefor being sent by the computer.

11. The computer-implemented method as recited in claim 8, comprising sending, by the computer, a request for the predefined configuration information upon detecting a hardware change in the computer.

12. The computer-implemented method as recited in claim 8, wherein the predefined configuration information includes configuration information selected from the group consisting of: account configuration information, network adapter configuration information, and storage adapter configuration information.

13. The computer-implemented method as recited in claim 8, wherein another computer is designated as a second leader to send second predefined configuration information to the other computers in the management network group, the second leader being configured with the second predefined configuration information.

14. A computer-implemented method, comprising:
receiving, by a computer, a designation as a leader to send predefined configuration information to other computers in a management network group, the computer being configured with the predefined configuration information;
determining, by the computer, that at least one of the other computers has an inconsistency between the predefined configuration information and the configuration information applied to the at least one of the other computers; and
sending, by the computer, the predefined configuration information to the at least one of the other computers for application of the predefined configuration information by the at least one of the other computers.

15. The computer-implemented method as recited in claim 14, wherein determining that the at least one of the other computers has an inconsistency includes auditing the other computers in the management network group for configuration information that does not match the predefined configuration information; and in response to detecting configuration information that does not match the predefined configuration information in one of the other computers, sending the predefined configuration information to the other computer.

16. The computer-implemented method as recited in claim 14, wherein the inconsistency is determined in response to receiving, by the computer, updated configuration information, and further comprising applying the updated configuration information to the computer; and sending, by the computer, the updated configuration information to the other computers.
